(19) United States
(12) Patent Application Publication
(10) Pub. No.: US 2012/0094216 A1
(43) Pub. Date: Apr. 19, 2012

(54) NANO-MATERIAL CATALYST DEVICE

(75) Inventors: R. Douglas Carpenter, Tustin, CA (US); Robert Brian Dopp, Marietta, GA (US); Kimberly McGrath, Newport Beach, CA (US)

(73) Assignee: QuantumSphere, Inc., Santa Ana, CA (US)

(21) Appl. No.: 13/272,171

(22) Filed: Oct. 12, 2011

Related U.S. Application Data
(63) Continuation of application No. 13/032,585, filed on Feb. 22, 2011, now abandoned.
Application No. 13/032,585 is a continuation of application No. 11/525,469, filed on Sep. 22, 2006, now abandoned.
Application No. 11/525,469 is a continuation-in-part of application No. 10/983,993, filed on Nov. 8, 2004, now Pat. No. 7,897,294.

(51) Int. Cl. H01M 4/86; C25B 11/06; G01N 27/30; H01M 4/92; H01M 4/90; B82Y 30/00

(52) U.S. Cl. 429/517; 429/523; 429/532; 429/524; 429/525; 429/526; 429/527; 429/528; 429/534; 204/290.01; 204/290.1; 204/400; 977/773

(57) ABSTRACT

A catalyst member comprising a blended mixture of nano-scale metal particles compressed with larger metal particles and sintered to form a structurally stable member of any desired shape. The catalyst member can be used in one of many different applications; for example, as an electrode in a fuel cell or in an electrolysis device to generate hydrogen and oxygen.

### CROSS-REFERENCE TO RELATED APPLICATIONS

This application is a continuation of co-pending U.S. patent application Ser. No. 13/032,585, filed Feb. 22, 2011, which is a continuation of U.S. patent application Ser. No. 11/525,469, filed Sep. 22, 2006, now abandoned, which is a continuation-in-part of U.S. patent application Ser. No. 10/983,993, filed Nov. 8, 2004, now U.S. Pat. No. 7,897,294, issued Mar. 1, 2011, the entire contents of each of which are incorporated herein by reference.

### BACKGROUND OF THE INVENTION

1. Technical Field

The inventions disclosed herein generally relate to catalysts for electrochemical reactions, for example, electrodes for use in fuel cells and electrolysis devices.

2. Related Art

Hydrogen is a renewable fuel that produces zero emissions when used in a fuel cell. In 2005, the Department of Energy (DoE) developed a new hydrogen cost goal and methodology, namely to achieve $2.00-3.00/gasoline gallon equivalent (gge, delivered, untaxed, by 2015), independent of the pathway used to produce and deliver hydrogen. The principal method to produce hydrogen is by stream reformation. Nearly 50% of the hydrogen currently being produced is made by steam reformation, where natural gas is reacted on metallic catalyst at high temperature and pressure. While this process has the lowest cost, four pounds of the greenhouse gasses carbon monoxide (CO) and carbon dioxide (CO₂) are produced for every one pound of hydrogen. Without further costly purification to remove CO and CO₂, the hydrogen fuel cell cannot operate efficiently.

Alternatively, 5% of hydrogen production is from water electrolysis. This reaction is the direct splitting of water molecules to produce hydrogen and oxygen. Note that greenhouse gasses are not produced in these reactions. In this process, electrodes composed of catalyst particles are submersed in water and energy is applied to them. Using this energy, the electrodes split water molecules into hydrogen and oxygen. Hydrogen is produced at the cathode electrode which accepts electrons and oxygen is produced at the anode electrode which liberates electrons. The efficiency of the catalyst electrode dictates how much hydrogen and oxygen is produced at any one current level. If the catalyst is highly efficient, there will be minimal energy input to achieve a maximum hydrogen output. Unfortunately, this process is currently too expensive to compete with steam reformation due to the expense of platinum which until now was the only effective catalyst for the electrochemical reaction.

Fuel cells are presently used to convert hydrogen rich fuel into electricity without combusting the fuel. For example, methanol, propane, and similar fuels that are rich in hydrogen and/or pure hydrogen gas fuel cell systems have been developed which generate electricity from the migration of the hydrogen in those fuels across a membrane. Because these fuels are not burned, pollution from such fuel cells is quite low or non-existent.

These fuel cells are generally more than twice as efficient as gasoline engines because they run cooler without the need for insulation and structural reinforcement. Additionally, some fuels such as methanol, are relatively inexpensive.

A single “cell” of a hydrogen-type fuel cell system or “fuel cell stack” usually consists a single electrolyte sandwiched between electrodes. This sandwich is disposed between current collectors which usually serve as the poles (i.e., the anode and cathode) of the cell.

Such a fuel cell generates current by transforming or dissociating (usually by using the catalyst in the electrodes) hydrogen gas into a mixture of hydrogen ions and electrons with a catalyst on the anode side of the cell. Because of the insulating nature of the electrolyte, the ions transfer through the electrolyte to the cathode side of the cell while the electrons are conducted to the current collectors and through a load to do work. The electrons then travel to the cathode side current collector where they disperse onto the electrodes to combine with incoming hydrogen ions, oxygen, or air in the presence of a catalyst to form water completing the circuit. This process occurs in many types of fuel cells, including for example, but without limitation, alkaline, solid polymer, phosphoric acid and solid oxide fuel cells.

Recently, the solid polymer membrane fuel cell has become the focus of much attention. A broad spectrum of industries, including automotive and power utilities, are now developing solid polymer membrane fuel cells for use with hydrogen fuels.

The cost of certain components of the solid polymer membrane fuel cell systems, as well as other factors, has slowed the commercialization of these systems. For example, the cost of platinum used for the catalyst of the modern solid polymer membrane fuel cell remains as a barrier to the production of low cost fuel cell systems.

### SUMMARY OF THE INVENTION

An aspect of at least one of the embodiments disclosed herein includes the realization that a catalyst device providing about the same performance of a platinum catalyst device can be manufactured with other less expensive materials by using nano-scale reactive metal particles of such less expensive materials. In modern solid polymer membrane fuel cells, platinum is the primary ingredient in the catalyst devices because platinum has a high surface energy density. However, platinum is costly. Thus, the cost of such catalyst devices, and thus fuel cell systems, as well as other systems using platinum catalysts, can be reduced by using other less expensive materials that are configured to provide about the same effective total surface energy as modern platinum catalyst devices.

Some disclosed embodiments allow the use of more cost-efficient metals as catalysts in electrodes, for example nickel, iron, manganese, cobalt, and tin, and alloys thereof, and their respective oxides for the generation of hydrogen and oxygen from water, or the reduction of oxygen or oxidation of hydrogen or hydrocarbon fuels. Lead, molybdenum, tungsten, chromium, silver, gold, and copper, and their associated alloys and oxides, among other metals, are also useful in some embodiments.

In a first aspect, a composition is provided that comprises (a) a plurality of reactive metal particles; and (b) metal substrate particles. Preferably, the reactive metal particles have a higher surface area and higher reactivity than the metal substrate particles. Most preferably, the reactive metal particles have a significantly higher surface area than the metal substrate particles, such that the reactive metal particles cover a significant portion of the surface of the metal substrate particles.

The reactive metal particles have a diameter of less than 1000 nm. Such particles are generally referred to as “nanoparticles”. Preferably, the nanoparticles have a diameter of less than about 100 nm, more preferably less than about 25 nm, and most preferable less than about 10 nm.

The metal substrate particles have a diameter of less than 5 microns. Preferably, the micron-sized particles have a diameter of less than about 2 microns, more preferable less than about 1 microns, and most preferable less than about 0.5 microns.

In the preferred embodiments, the reactive metal or metals that comprise the nanoparticles are preferably selected from the group of metals from groups 3-16, and the lanthanide series. More preferably, the metals are transition metals, mixtures thereof, and alloys thereof and their respective oxides. Most preferably, the metal or metals are selected from the group consisting of nickel, iron, manganese, cobalt, tin, and silver, or combinations, alloys, and oxides thereof.

In the preferred embodiments, the reactive metal or metals that comprise the metal substrate particles are preferably selected from the group of metals from groups 3-16, and the lanthanide series. More preferably, the metals are transition metals, mixtures thereof, and alloys thereof and their respective oxides. Most preferably, the metal or metals are selected from the group consisting of nickel, iron, manganese, cobalt, tin, and silver, or combinations, alloys, and oxides thereof.

In some preferred embodiments, the reactive metal particles comprise an oxide of the metal or alloy. The nanoparticles can have an oxide shell; for example, an oxide shell comprising less than 70 wt. % of the total weight of the particle. In other embodiments, the particles can be oxidized and comprise entirely or partially of an oxide of the metal or alloy.

In other embodiments, it is preferable that the reactive metal particles and metal substrate particles be compressed and sintered by heating such that a 3-dimensional compact is formed. Preferably, the compact has a fraction of its surface area within the inside volume of the compact, and most preferably, a significant portion of the active area lies within the interior volume, with the remaining internal area comprising void volume. To increase the active area and allow for effective gas and fluid flow, nanoparticles are blended with larger, metal, substrate particles. The larger, metal, substrate particles provide, amongst other value, structural integrity, and the outer surface of the metal substrate particles are coated with nanoparticles for increased reactive surface area.

Electrodes can be formed from the compositions of the preferred embodiments. In some embodiments, the electrode is a compressed mixture of metal substrate particles, nanoparticles, and a current collector. The current collector is preferably a metal high electrical conductivity and electrochemical stability, and most preferably is a metal mesh screen with high surface area. In one embodiment, the electrodes have a first and second face, with the embedded current collector preferably positioned proximal the second face.

In some embodiments, the composition is volumetrically compressed relative to its original volume such that the composition maintains mechanical stability and also provides sufficient permeability to the reacting species.

In some embodiments, the electrode can be followed by a heating treatment, preferably between 100-900° C. and most preferably between 400-700° C. to sinter metal particles together to provide structural integrity.

In other embodiments disclosed herein, an electrolyzer is described, to split water molecules into hydrogen and oxygen on a catalyst surface when energy is applied. The electrolyzer comprises two electrodes, one acting as an anode terminal and one acting as a cathode terminal. When these electrodes are submersed in a liquid electrolyte and electricity is applied to the current collector, hydrogen is generated at the cathode terminal and oxygen is generated at the anode terminal. Preferably, these electrodes are less than ten cm apart, more preferably less than one cm apart, and most preferably less than one millimeter apart. Further, the electrodes can be laminated on a first face of a separator less than one millimeter thick that substantially prevents the permeation of gasses to avoid the mixture of hydrogen and oxygen gas, but allows aqueous electrolyte flux. More preferably, the separator is hydrophobic, and most preferably the separator is a fluorocarbon.

In yet another embodiment, an anode terminal and a cathode terminal are compressed to either side of an ion exchange membrane. When the assembly is exposed to water, hydrogen can be generated at the cathode terminal and oxygen can be generated at the anode terminal. This configuration is highly desirable in that the volume of the device is minimized and there is no need for an aqueous electrolyte.

In accordance with at least one of the embodiments disclosed herein, a fuel cell configured to generate electrical energy from reactions of a gaseous fuel and air comprises a proton exchange membrane and at least first and second catalyst members. The catalyst members are disposed on opposite sides of the proton exchange membrane. The first and second catalyst members comprise sintered metal nanoparticles.

### BRIEF DESCRIPTION OF THE DRAWINGS

The features mentioned above in the summary of the invention, along with other features of the inventions disclosed herein, are described below with reference to the drawings of the preferred embodiments. The illustrated embodiments in the figures listed below are intended to illustrate, but not to limit the inventions.

FIGS. 1-9 schematically illustrate prior art fuel cell systems.

FIG. 1 is a perspective view of a prior art fuel cell stack;

FIG. 2 is enlarged sectional view of a single fuel cell in the fuel cell stack of FIG. 1;

FIG. 3 illustrates a flow of hydrogen rich fuel into the fuel side of the fuel cell of FIG. 2 and a flow of air into the air side of the fuel cell of FIG. 2;

FIG. 4 illustrates a hydrogen rich fuel and air disposed on the fuel and air sides of the fuel cell of FIG. 2;

FIG. 5 illustrates the disassociation of the hydrogen fuel into electrons and protons in the fuel cell of FIG. 2;

FIG. 6 illustrates the movement of the protons from the fuel having traveled through the membrane electrode assembly and the movement of electrons along the anode of the membrane electrode assembly and toward a load device;

FIG. 7 illustrates the electrons from the anode returning to a cathode of the membrane electrode assembly after having traveled through a load device;

FIG. 8 illustrates the reassociation of the electrons with protons followed by their combining with a molecule of oxygen to form water on the air side of the fuel cell;

FIG. 9 illustrates the combined water molecules leaving the air side of the fuel cell.

FIG. 10 is sectional view of a single fuel cell including a catalyst device constructed in accordance with one embodiment.

FIG. 11 is a schematic illustration of a device for performing electrolysis of water having catalysts devices constructed in accordance with another embodiment.

FIG. 12 is a transition electron microscopy (TEM) photograph of nickel nanoparticles comprising an oxide shell.

FIG. 13 is a side view of the electrode.

FIG. 14 is a picture of a sintered electrode.

FIG. 15 is a scanning electron microscopy (SEM) photograph of a face of the electrode, with magnification.

FIG. 16 is a side view of the electrode with a contoured geometric surface.

FIG. 17 is an electrolysis device configured to generate hydrogen and oxygen from aqueous electrolyte.

FIG. 18 compares the efficiency of the electrodes described herein versus typical electrodes.

FIG. 19 is a voltammogram comparing the electrical performance of the electrodes described herein versus typical electrodes.

The features mentioned above in the summary of the invention, along with other features of the inventions disclosed herein, are described below with reference to the drawings of the preferred embodiments. The illustrated embodiments in the figures listed below are intended to illustrate, but not to limit the inventions.

### DETAILED DESCRIPTION

Devices which are configured to convert chemical energy into electrical energy are generally referred to as batteries. Fuel cells are a special class of batteries in which high-energy chemical reactants are continuously fed into the battery and the lower energy chemical products are continuously removed. However, fuel cells cannot store chemical energy like, for example, lead-acid batteries can.

Batteries can comprise one or several individual cells. A single cell includes a negative electrode and a positive electrode. An electrolytic solution separates the electrodes. When the cell is discharging (converting chemical energy to electrical energy), an oxidation reaction occurs at the negative electrode (anode). At the positive electrode (cathode), a reduction reaction occurs during discharging.

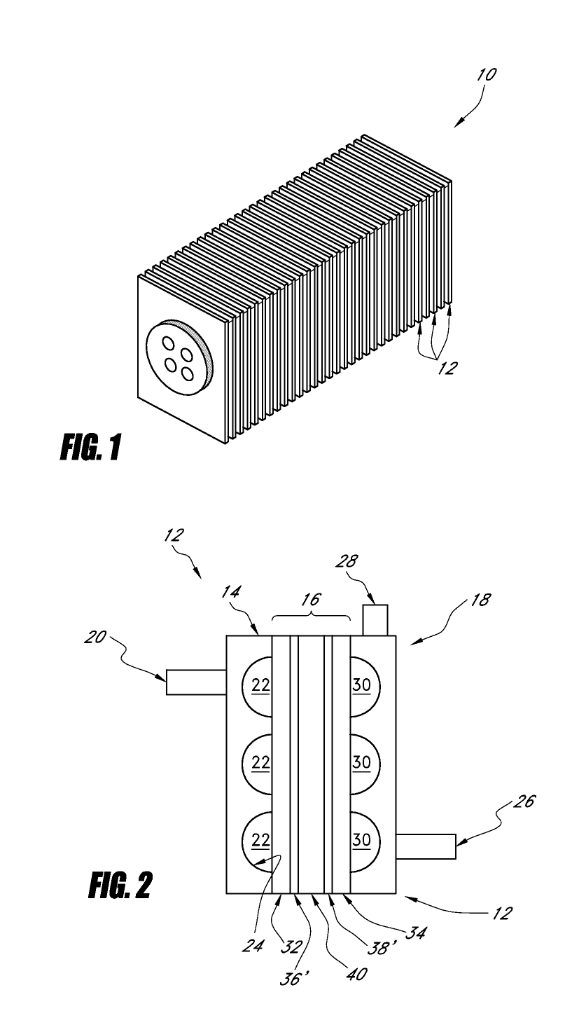

For the electrode reactions of any corresponding pair of anodes and cathodes (also known as an electrochemical couple), electrons pass from the anode, through an external circuit such as an electric motor or storage device, to the cathode. Completion of the circuit occurs when ionic species are transferred across the cell through the intervening electrolyte. The change from electronic conduction to ionic conduction occurs at the electrode and involves an electrochemical (Faradaic) reaction. However, electrons cannot pass through the electrolyte, or short circuiting will resort in cell self-discharge. An example of a known prior art hydrogen/air fuel cell is illustrated in FIGS. 1-9.

As shown in FIG. 1, a fuel cell stack 10 is made up of the plurality of individual fuel cells 12. Each fuel cell can be comprised of a pair of plates and a membrane electrode assembly. One plate defines a flow area between an inner surface of the plate and one surface of the membrane electrode assembly (MEA) while the other plate defines a second flow area between the second plate and other side of the membrane electrode assembly. The two flow areas are separated from each other. Thus, fuel can be supplied to one of the flow areas and air, or another oxygen carrying medium, can be supplied to the other flow area.

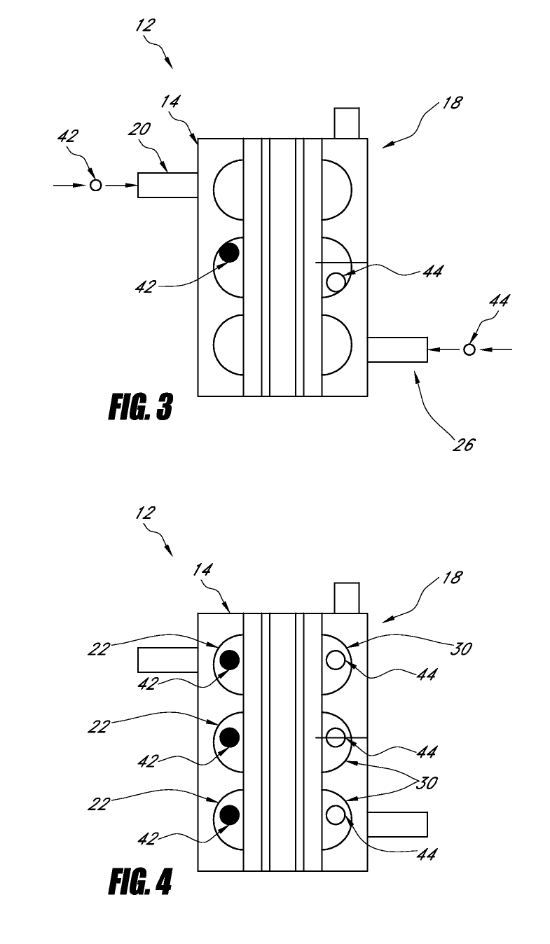

FIG. 2 illustrates an enlarged schematic sectional view of a single cell 12. Only a single cell is illustrated in FIG. 2 for simplicity. One of ordinary skill in the art understands how to use a plurality of the individual cells 12 to construct a fuel cell stack 10.

As shown in FIG. 2, the cell 12 includes a fuel-side plate 14, a membrane electrode assembly (MEA) 16 and air-side plate 18. The fuel-side plate 14 is typically constructed of machined graphite. The plate 14 defines a fuel inlet 20 and a fuel flow area 22. The fuel inlet 20 is connected to the fuel flow area 22. The fuel flow area 22 can be constructed from surface features on an inner surface 24 of the plate 14. For example, the fuel flow area 22 can be comprised of channels or other flow resistance or mixing features for generating a mixed and/or evenly spread flow of fuel through the flow area 22.

Plate 18 can be configured in a substantially similar or identical manner, depending on the type of fuel cell. In the illustrated example, the fuel cell stack 10 is configured to convert pure hydrogen gas into electricity through reaction with air. Thus, the plate 14 does not have an outlet for discharging material from the flow area 22. Rather, in this type of fuel cell, all of the supplied fuel is consumed.

However, the plate 18, because it is designed to receive air and to discharge the by products of the reaction, namely water and carbon dioxide (CO sub.2), includes an air inlet 26 and an exhaust outlet 28. Additionally, similarly to the flow area 22, the plate 18 also defines a flow area 30 which can be constructed generally in accordance with the description set forth above with respect to the flow area 22. Additionally, in prior art systems, plates such as the plates 14 and 18 have been formed from machined graphite.

The membrane electrode assembly 16 typically comprises two electrodes, for example, an anode 32 and a cathode 34. The anode 32 and the cathode 34 are disposed so as to be in contact with the fuel flowing in flow areas 22 and the air flowing in the flow areas 30, respectively. The MEA 16 also includes catalyst devices 36, 38 and a proton exchange membrane 40. The construction of these devices are well known in the art, however, a more detailed description is set forth below.

Anode 32 and the cathode 34 serve as the negative and positive electrodes, respectively. In operation, several processes are involved. The processes can be summarized as: gas transfer to reaction sites, electrochemical reaction at those sites, the transfer of ions and electrons, and their recombination at the cathode.

In some designs, gas is diffused through the electrode leaving behind any impurities which may disrupt the reaction. Gases move toward the reaction sites within the catalyst device 36 based on the concentration gradient between the fuel flow areas 22 (high concentration) and the reaction sites (low concentration). Platinum, which is typically used as the catalyst in the catalyst members 36, 38, cooperates with the electrode members 32, 34 and can thus together serve as the electrodes. Thus, the catalyst member 36 and the electrode member 32 can be considered a single member depending on the construction used. For example, because platinum is a conductive metal, the catalyst member 36 can be electrically connected with wires and thus serve as an electrode itself. In some embodiments, the platinum is supported by supporting structures, such as, for example, but without limitation, graphite or other conductive members which are connected to wires for completing an electric circuit.

The concentration gradient noted above refers to the difference between the concentration of free flowing gas in the flow areas 22, 30 and the concentration at the reaction sites in the catalyst. This gradient varies depending on pressure and temperature of the gases and the diffusion coefficient of the electrode material. When gas comes near the reaction sites, the flow is dominated by a capillary action based on the reaction rates at the sites.

Two main electrochemical reactions occur in a fuel cell; one at the anode 32, 36 and the other at the cathode 34, 38. At the anode 32, 36, and more particularly, in the catalyst member 36 hydrogen gas molecules are dissociated into (positively charged) hydrogen ions and electrons (H₂⇄2H⁺+2e⁻). This occurs when hydrogen fuel enters a reaction site within the catalyst member 36 and is broken into ions and electrons. The resulting ions (H⁺) form bonds with the catalyst surface while electrons (e⁻) remain near the ions until another fuel molecule begins to react with the catalyst 36, thus breaking the bond with the ion.

The number of reaction sites within a catalyst, such as the platinum catalyst member 36, are generally determined by the surface energy density of the catalyst material and the total amount of surface area of the catalyst material. For example, the number of reaction sites of a catalyst device is roughly proportional to the surface energy density times the total surface area. A reaction site can be considered to be a point or area on the surface of the catalyst material that has sufficient surface energy available to break a hydrogen molecule into hydrogen ions and electrons.

With reference again to the reaction occurring at the catalyst member 36, this reaction releases hydrogen ions and electrons whose transport is crucial to energy production. The ions build up on the anode 32, 36 creating a positive potential which pushes the outer ions away from the anode 32, 36. The ions transfer through the electrolyte of the membrane 40 either by remaining connected to or an attraction to a water molecule which travels through the membrane 40, or by transferring between water molecules. The oxygen side of the water molecules contains a slight negative charge which attracts the positively charged hydrogen ions and may become attached to them, but the attraction is weak so any bonds formed are easily broken. The actual method of transfer varies, but is based on the thickness of the membrane 40, the amount of water in the membrane 40 and the number of ions transported. Thus, the anode 32, 36 contains a net positive charge while the cathode 34, 38 towards which the ions drift, contains a negative potential.

At the catalyst member 38, the hydrogen ions are recombined with electrons that have flowed from the anode and across a load as well as with oxygen (2H⁺+½O₂+2e⁻⇄H₂O). Oxygen molecules, usually from atmospheric air, are broken up into their components by the catalyst member 38. The resulting water is ejected into the gas channel and out of the cell 12.

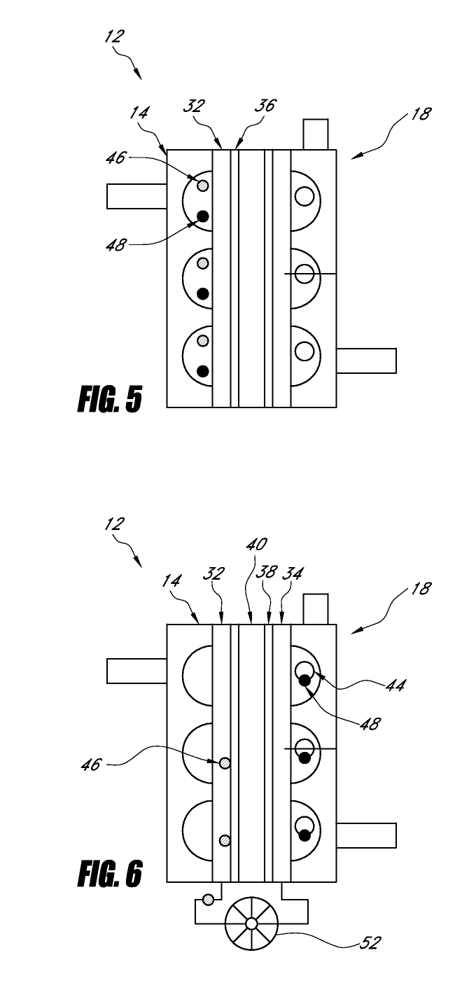

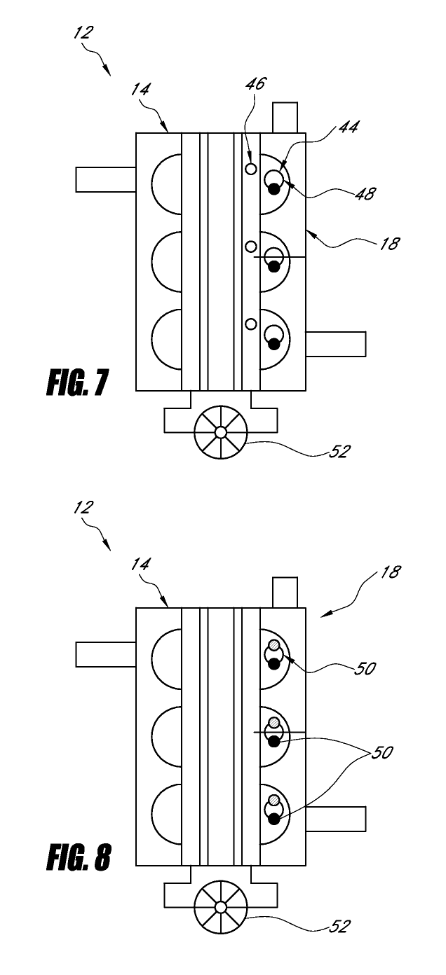

FIGS. 3 and 4 schematically illustrate the flow of hydrogen molecules 42 flowing into the flow areas 22 as well as the flow of air molecules, and in particular oxygen 44, flowing into the flow areas 30.

With reference to FIG. 5, the disassociation of electrons 46 from the protons 48 forming the previously introduced hydrogen molecule 42 (FIG. 4) is schematically illustrated. This dissociation occurs at reaction sites in the catalyst member 36. When the hydrogen molecules 42 reach the reaction sites within the catalyst 36, hydrogen molecules (H₂) disassociate so as to form two hydrogen ions (2H⁺) 48 and two electrons (2e⁻) 46.

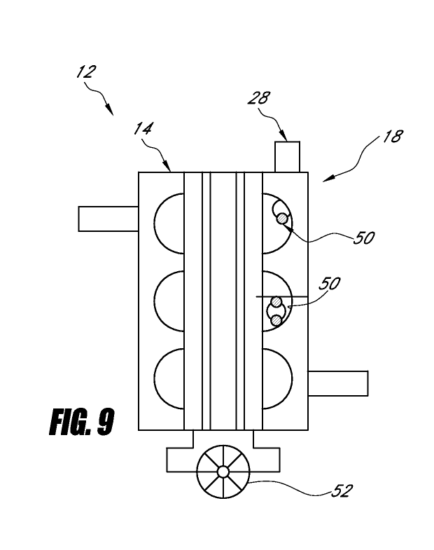

With reference to FIG. 6, the proton exchange membrane 40 allows the hydrogen ions 48 to pass there through, however, inhibits the electrons 46 from passing there through. The buildup of electrons 46 in the anode 32 generates a net negative charge at the anode.

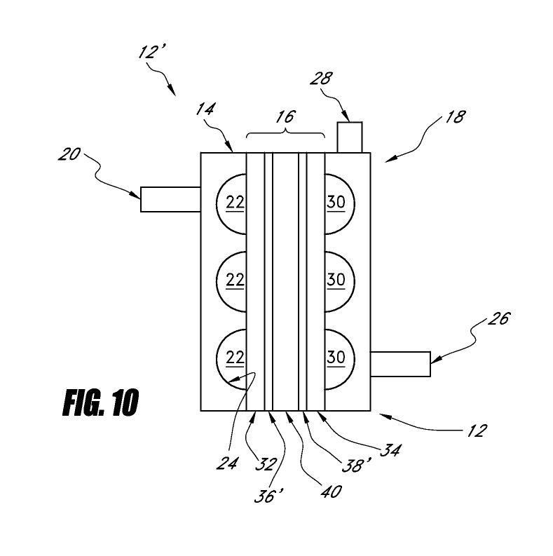

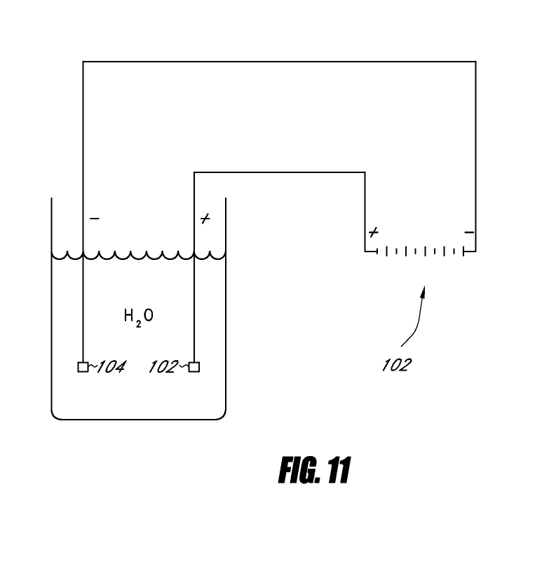

Additionally, as shown in FIG. 7, at the reaction sites in the catalyst member 38, the hydrogen ions (H⁺) 48 combine with oxygen molecules 44 and recombine with electrons 46 returning from the load device 52 to form water (H₂O) 50 (FIG. 8).

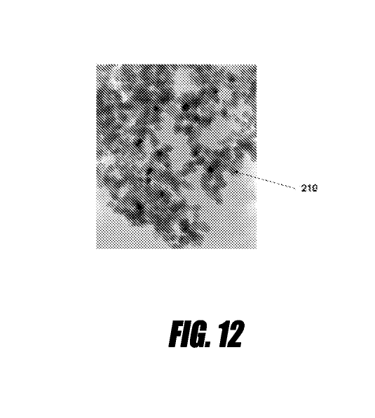

With continued reference to FIG. 8, the movement of the electrons 46 from the anode 32 to the cathode 34 can be applied to a load device, such as, for example, but without limitation, an electric motor 52. The electrons 46 are drawn to the cathode 34 due to the positive charge on the hydrogen ions 48. FIG. 9 illustrates the discharge of the water molecules through the exhaust outlet 28.

As noted above, typically platinum is the main component of catalyst members used in fuel cell systems. However, platinum is relatively expensive and is one factor in preventing the widespread use of such fuel cell systems.

An aspect of at least one of the embodiments disclosed herein includes the realization that nanometal particles, including nickel (Ni) in nanometer size, can be configured to have a surface energy sufficiently high to replace platinum commonly used in the catalyst members of modern hydrogen fuel cell systems. For example, although nickel generally has a lower surface energy density than that of platinum, nickel can be formed into a nano-scale particle. As such, a nano-scale particle of nickel can have an exponentially higher surface area-to-volume ratio than that of a micron-scale platinum particle. Thus, a catalyst member, such as the catalyst members 36 and 38 can be formed from nano-scale nickel particles and provide a sufficient number of reaction sites so as to perform about the same as a platinum catalyst device.

FIG. 10 illustrates a fuel cell 12′ having metal nanoparticle catalyst devices. The fuel cell 12′ of FIG. 10 includes the same or similar components of the fuel cell 12 which are identified with the same reference numerals used to identify those components of the fuel cell 12, except that a “′” has been added thereto. Additionally, those components that can be constructed in the same or similar manner are not described in further detail

The catalyst members 36′, 38′ can be formed from metal nanoparticles. For example, the catalyst members 36′, 38′ can be formed of powderized nickel having a particle size on the nano-scale, e.g., from about 1 to 100 nanometers (nm). In some embodiments, the particle size can be less than about 100 nm. In some embodiments, the particles can be less than about 50 nm. In other embodiments, the metal nanoparticles can be less than about 10 nm.

The nano-scale nickel particles can be formed into a plate shape with any known technique, including, for example, but without limitation, sintering, cold working, etc.

Where the nano-scale nickel powder is sintered, in some embodiments, the powder can be compressed volumetrically. In the sintering process, the particles will be urged into electrical contact with each other, while leaving interstitial pores thereby allowing conduction of electrons through the plate as well as allowing gas and vapor molecules to pass through the pores.

Preferably, the compression of the powder is sufficient to provide continuous electrical pathways substantially throughout the resulting plate of metal particles. Additionally, it is preferable that the compression does not completely close off the pores so as to ensure that water, water vapor, hydrogen molecules, hydrogen ions, as well as other molecules can pass through the catalyst member 36′ and into the membrane 40.

In some embodiments, the sintering process can include placing metal nanoparticles particles, either alone or with additional alloying particles, into a mold and compressing the particles under high pressure to a near net shape compact.

The compact can be sintered to a porous membrane by furnace heating and quenching. This method can be performed quickly, inexpensively, and requires commonly available equipment. Additionally, there are few restrictions on the size and shape of the finished product.

Optionally, the method of manufacturing can include sealing the green compact in a nickel can and consolidated by hot isostatically pressing (HIP). Following HIPing the outer nickel can be removed using electrostatic discharge machining (EDM) techniques. The HIP process provides further advantages in that temperature, atmosphere and thus grain growth can be better controlled.

In some embodiments, the method of manufacturing can be performed by compaction plasma sintering of the nickel particles. For example, but without limitation, a machine currently commercially available under the trade name Dr. Sinter from the Sumitomo Coal Company can be used to perform such a process. Such rapid sintering provides a further enhancement of grain growth control. For example, such a process can achieve a satisfactory sintering of the nickel particles in a period of seconds, thereby providing better grain growth control.

As noted above, the final size and shape of the catalyst device 36′, 38′ can be obtained by cutting using the EDM process. Although other machining techniques can also be used, the EDM process provides a further advantage in that pores in the resulting sintered member are better preserved.

After the sintered members are machined or otherwise formed into their final shape, they can be installed into the fuel cell 12′ so as to serve as the catalyst members 36′, 38′ or as combined catalyst and electrode members.

Optionally, the sintered members can include other materials. For example, but without limitation, aluminum can be added to the nano-scale nickel particles prior to sintering. In some embodiments, nano-scale aluminum powder can be mixed with the nano-scale nickel powder to form a mixture of about 80% nickel and 20% aluminum by weight. However, other materials and other proportions can also be used.

In some embodiments, the catalyst members 36′, 38′ can include silver particles. The effects of silver in this type of catalyst device are well known, and are not repeated herein. In some embodiments, the silver particles can be nano-scale particles. For example, the silver particles can be less than about 100 nm, less than about 50 nm, and/or less than ten nm. Such silver particles can be mixed with any of the sizes of nickel particles noted above. In such nickel and silver particle embodiments, the catalyst members 36′, 38′ can be formed of about 80-95% nickel particles and 5-20% silver particles. In some embodiments, the catalyst members 36′, 38′ can be formed of about 90-95% nickel particles and 5-10% silver particles.

Additionally, in some embodiments, the catalyst members 36′, 38′ can include aluminum and silver particles. For example, the catalyst members 36′, 38′ can include any combination of the above noted proportions of aluminum and silver, with the remainder being nickel particles.

In some embodiments, the catalyst members 36′, 38′ can also include ruthenium particles, which are commonly used in catalysts exposed to sulfur and oxides of carbon. The effects of ruthenium in this type of catalyst device are well known, and are not repeated herein. In some embodiments, the ruthenium particles can be nano-scale particles. For example, the ruthenium particles can be less than about 100 nm, less than about 50 nm, and/or less than about 10 nm. Such ruthenium particles can be mixed with any of the sizes of nickel particles noted above. In such nickel and ruthenium particle embodiments, the catalyst members 36′, 38′ can be formed of about 85-99% nickel particles and 1-15% ruthenium particles.

Additionally, in some embodiments, the catalyst members 36′, 38′ can include aluminum and ruthenium particles. For example, the catalyst members 36′, 38′ can include any combination of the above noted proportions of aluminum and ruthenium particles, with the remainder being nickel particles. Finally, such aluminum and ruthenium particle catalyst members 36′, 38′ can include silver as well. For example, the catalyst members 36′, 38′ can include any combination of the above noted proportions of aluminum, ruthenium, and silver particles, with the remainder being nickel particles.

The nickel, aluminum particles, silver, and ruthenium can have various shapes. For example, some nano-particle manufacturing techniques generate particles with generally cubic or partially-crystalline shapes while others produce particles that are more spherical. Thus, although the sizes of particles can be expressed as a diameter, the term diameter is not intended to require that the particle is spherical. Rather, where the term diameter is used, it is intended to apply to any shape particle. Thus, a cubic or crystalline-shaped particle can be measured by placing an imaginary sphere over the particle so as to define a diameter of the particle.

Further, after such particles have been sintered, particles can be fused to adjacent particles. Thus, it is intended that the size of the particle in a sintered member refers to the surfaces of the particle that are not fused to an adjacent particle. Thus, in a manner similar to that noted above, an imaginary sphere can be used to approximate the size of a particle that has been fused or sintered to an adjacent particle.

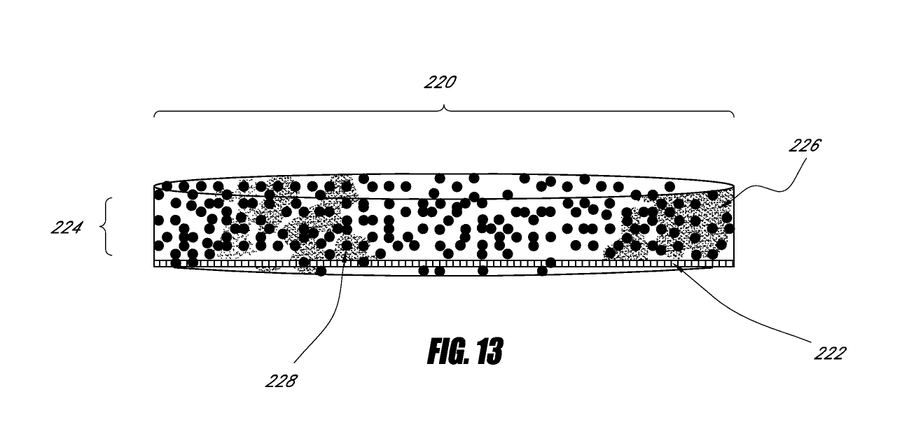

In accordance with another embodiment, the same manufacturing processes noted above can be used to form catalysts for the electrolysis of water. With reference to FIG. 11, the basic electrolysis of water process is well known in the art. In this process, energy from an electrical source, such as a battery 100, is used to dissociate water (H₂O) into the diatomic molecules of hydrogen (H₂) and oxygen (O₂). In this basic example, two different dissociation reactions occur.

At the anode 102, water is oxidized (2H₂O→O₂+4H⁺+4e⁻). On the other hand, at the cathode 104, water is reduced (4H₂O+4e⁻→2H₂+4OH⁻). Thus, bubbles of oxygen gas (O₂) form at the anode 102, and bubbles of hydrogen gas (H₂) form at the cathode 104.

Typically, where higher levels of electrical efficiency are desired, the electrodes 102, 104 are composed of platinum or platinum coated probes. As noted above with respect to the catalyst devices 36, 38, the platinum enhances the reaction rates due to the high surface energy provided by the platinum.

In accordance with at least one embodiment, the electrodes 102, 104 can be formed of nano-scale nickel particles, thereby providing a catalytic effect similar to that of a platinum probe. In some embodiments, the electrodes 102, 104 can be manufactured in accordance with the methods of manufacturing noted above with respect to the embodiment of FIG. 11. Thus, a further description of those methods will not be repeated.

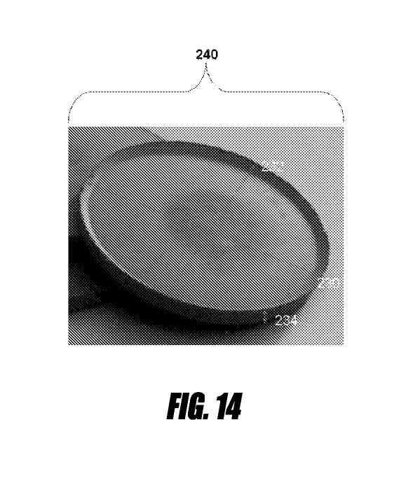

The increased surface area of the reactive metal particles, also known as “nanoparticles”, compared the surface area of the metal substrate particles is high due to the very large number of atoms on the surface of the nanoparticles. Referring to FIG. 12, a transmission electron micrograph of nickel nanoparticles is shown. Each nickel nanoparticle 210 has an oxide shell. As an example, a cube comprising a plurality of three nanometer nickel particles considered essentially as tiny spheres. As such, they would have about ten atoms on each side, about one thousand atoms in total. Of those thousand atoms, 488 atoms would be on the exterior surface and 512 atoms on the interior of the particle. This means that roughly half of the nanoparticles would have the energy of the bulk material and half would have higher energy due to the absence of neighboring atoms (nickel atoms in the bulk material have about twelve nearest neighbors while those on the surface has nine or fewer). A three micron sphere of nickel would have 10,000 atoms along each side for a total of one trillion atoms. There would be 999.4 billion of those atoms in the bulk (low energy interior) material. That means that only 0.06% of the atoms would be on the surface of the three micron-sized material compared to the 48.8% of the atoms at the surface of the three nanometer nickel particles.

The reactive metal particles can be formed through one of many known manufacturing techniques, including for example ball milling, precipitation, and vaporization-quenching techniques (such as joule heating, plasma torch synthesis, combustion flame, exploding wires, spark erosion, ion collision, laser ablation and electron beam evaporation). Another possible technique comprises a process of feeding a material onto a heater element so as to vaporize the material, allowing the material vapor to flow upwardly from the heater element in a controlled substantially laminar manner under free convection, injecting a flow of cooling gas upwardly from a position below the heater element, preferably parallel to and into contact with the upward flow of the vaporized material and at the same velocity as the vaporized material, allowing the cooling gas and vaporized material to rise and mix sufficiently long enough to allow nano-scale particles of the material to condense out of the vapor, and drawing the mixed flow of cooling gas and nano-scale particles with a vacuum into a storage chamber. Such process is described in more detail in U.S. patent application Ser. No. 10/840,409, filed May 6, 2004, now U.S. Pat. No. 7,282,167, issued Oct. 16, 2007, the entire contents of which is hereby expressly incorporated by reference. Other techniques may be used as well.

The chemical kinetics of catalysts generally depend on the reaction of surface atoms. Having more surface atoms available would increase the rate of many chemical reactions such as combustion (oxidation) and adsorption. Extremely short diffusion paths (five atoms from the particle center to the edge in the three-nanometer-particles example above) allow for fast transport of atoms through and into the particles for other processes. These properties give nano materials unique characteristics that are unlike those of corresponding conventional (micron and larger) materials.

It is contemplated that, in at least one of the embodiments disclosed herein, metal particles selected from the group consisting of metals from groups 3-16, lanthanides, combinations thereof, and alloys thereof can be configured to have a surface energy sufficiently high to enhance the performance of platinum.

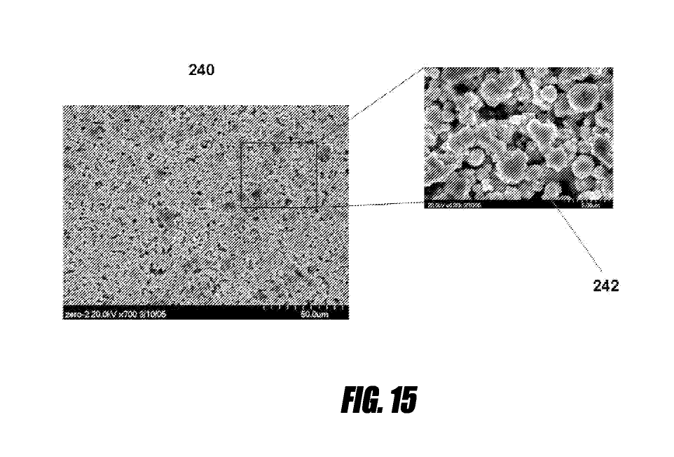

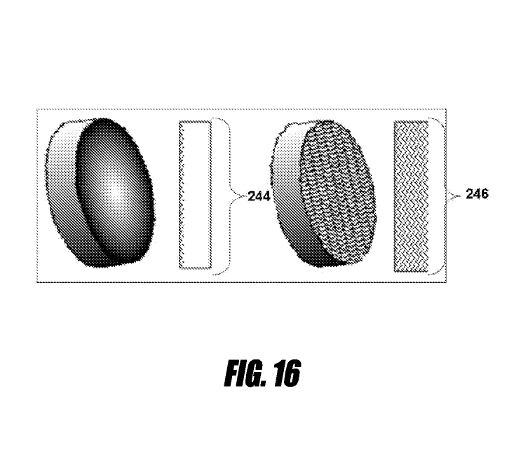

Referring to FIG. 13, an embodiment of a sintered electrode 220 may be described. Preferably, the electrode 220 comprises a current collector 222 and a compressed mixture 224 of metal substrate particles 226 and smaller reactive particles 228 have a preferably nanometer size. Desirably, the current connector is secured within the compressed mixture, or at least secured to the compressed mixture, but need not be. In a preferred embodiment, the electrode 220 may be made by placing the current collector 222 at the bottom of a die and then compressing the blend of metal substrate particles 224 and smaller reactive particles 226 on top of the collector such that the current collector 222 becomes embedded into one face of the electrode. It is also desirable, although it may not always be necessary, to sinter the resulting electrode, as explained further below. The electrode can be made into any desired shape; for example, as shown in FIG. 14, a disc. In any case, the electrode would comprise a dimension in one direction (e.g. length) 230, a dimension in another generally transverse direction (e.g., width) 232, and a dimension in another generally transverse direction (e.g., depth) 234.

Although other sizes are contemplated, the nanoparticles preferably have a diameter of less than 100 nm, more preferably less than 50 nm, and most preferably less than ten nm. The smaller the nanoparticles size, the more likely they are to efficiently coat the surface of the metal substrate particles.

Although other materials are contemplated, the nanoparticles and metal substrate particles are preferably selected from the group of metals from groups 3-16, and the lanthanide series. More preferably, the metals are transition metals, mixtures thereof, and alloys thereof and their respective oxides. Most preferably, the metal or metals are selected from the group consisting of nickel, iron, manganese, cobalt, tin, and silver, or combinations, alloys, and oxides thereof. Additionally, the nanoparticles have a metal core and an oxide shell, which can range from 1 to 100% of the total particle composition.

Referring to FIG. 13, the electrode 220 is shown prior to a sintering process. The current collector 222 is embedded into the electrode and serves the dual purpose of collecting current and providing additional structural support to the electrode. It is desirably made of a conductive expanded metal, such as nickel or other such conductive expanded metals. This enhances efficient collection of current across the entire electrode and to maintain optimal connection with the rest of the electrode. It is intended that there be significantly more nanoparticles 228 than there are metal substrate particles 226. The nanoparticles and metal substrate particles are preferably compressed volumetrically. This compression process brings the metal substrate particles and nanoparticles in intimate contact with one another with the desired result that the nanoparticles coat the surface of each metal substrate particle. The electrode 220 should be compressed at least with a force of 500-2000 psi to ensure that the particles maintain contact and structural stability. Preferably, the compression of the powder is sufficient to provide continuous electrical pathways substantially throughout the resulting compact of metal particles while avoiding closing off the internal voids to permit meaningful flow of liquid and/or through the electrode. It is preferable that the electrode be volumetrically compressed to a percentage of the mixture's original volume so as to minimize volume for, e.g., structural stability, while still permitting a sufficient amount of permeability to maintain a high catalytic efficiency.

Preferably, but not always necessarily, the electrode 220 can be sintered, for example between 100° and 900° C., and preferably between 400° and 700° C. This method can be performed quickly and inexpensively on commonly available equipment to create a compressed electrode of almost any desired size and shape. After sintering, at least some of the nanoparticles and metal substrate particles are expected to fuse together, as shown in the SEM image of FIG. 15, which results in the particles' individual morphology being largely maintained. As referenced herein, the size of the particle in a sintered member refers to the surfaces of a particle that is not fused to an adjacent particle. Thus, in a manner similar to that noted above, an imaginary sphere can be used to approximate the size of a particle that has been fused or sintered to an adjacent particle. A fraction of the volume of the pellet 240 is retained as void volumes 242, the level of which depends on both compression and sintering conditions. The void volumes 242 form tortuous pathways within the pellet 240, and the presence of high surface area nanoparticles on these inner pathways allow for excellent active electrochemical surface area. In the sintering process, the particles will be urged into electrical contact with each other, while leaving interstitial pores thereby allowing conduction of electrons through the compact as well as allowing liquid and vapor to pass through the pores.

In some embodiments, the manufacturing process can also include heating, as is commonly used in known sintering techniques. However, the heating of the reactive metal particles and metal substrate particles should be limited so as to not allow excessive grain growth. For example, if the reactive metal particles and metal substrate particles are heated excessively, thereby causing excessive grain growth, the particles combine to form larger particles. This growth reduces the surface area to volume ratio of the particles, and thereby reduces the number of reaction sites available for catalytic functions. One of ordinary skill in the art will recognize that any sintering process is likely to produce some grain growth, and thus it is anticipated that the resulting electrodes will include grains that have grown larger than the original nickel particles, including grain sizes that are larger than “nano-scale”. However, it is preferable to optimize the pressure and heating of the particles during the sintering process to preserve the nano-scale size of the original particles and yet form a plate member that is structurally stable.

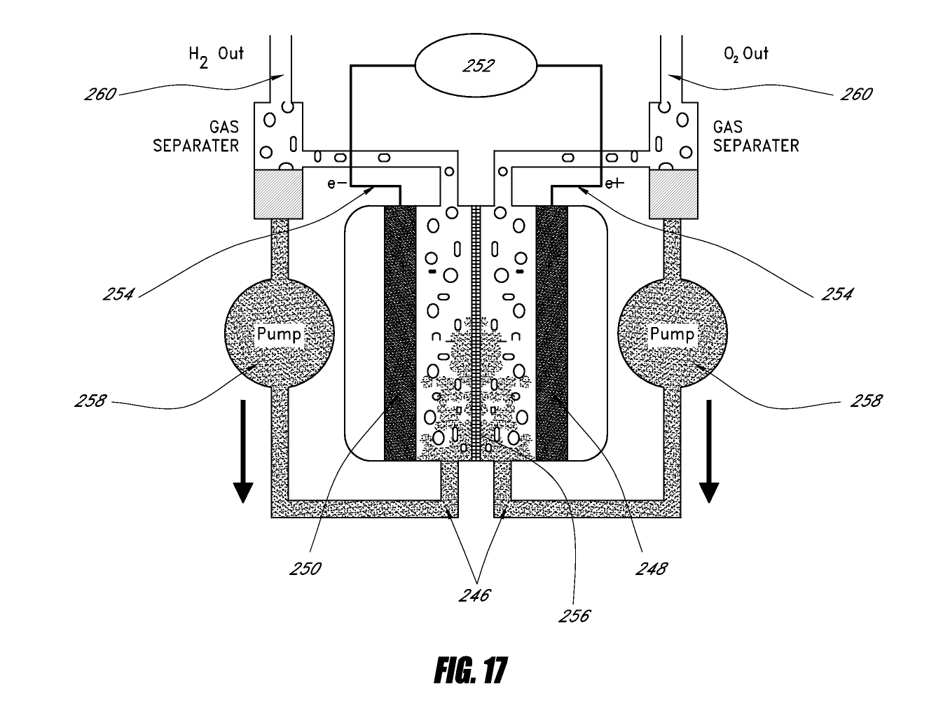

In addition, the form factor of the compression die can be altered to provided further increased geometric surface area to the face of the pellet 240 opposite the current collector 222. Referring to FIG. 16, a comparison can be made between an electrode 242 having a smooth face with an electrode 244 having contours that increase the geometric surface area.

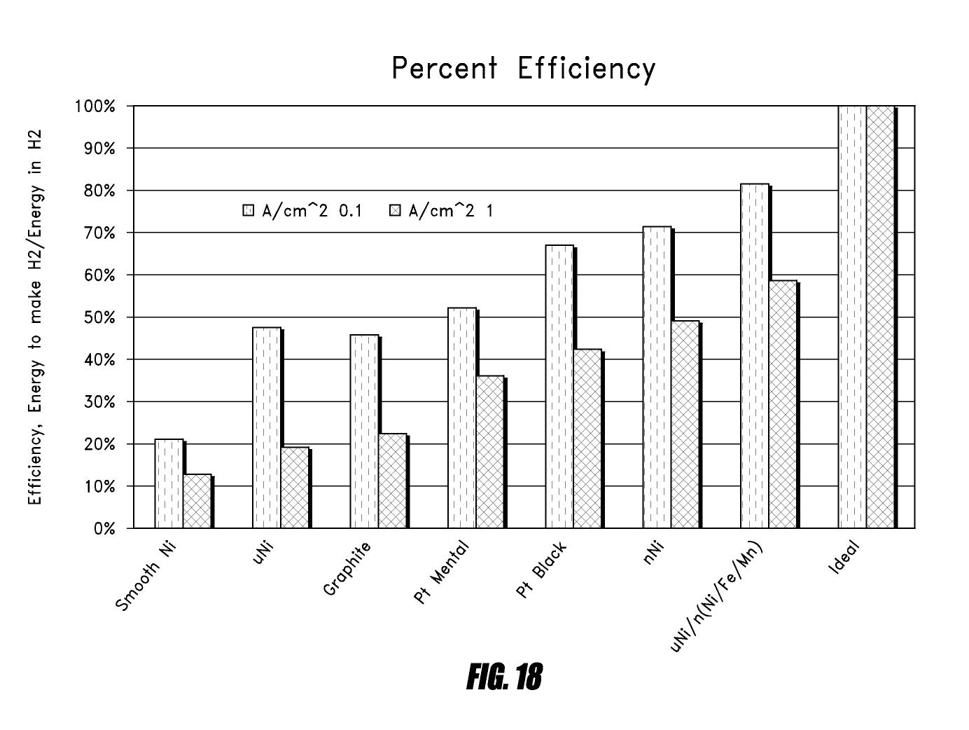

Devices that are configured to electrochemically convert water into hydrogen and oxygen when energy is applied are known as electrolyzers. An example of an electrolyzer is illustrated in FIG. 17. In this embodiment electrolyte 246 such as eutectic potassium hydroxide (KOH), is circulated in the anode and cathode chambers. The anode electrode 248 produces oxygen by the reaction 2OH⁻→H₂O+½O₂+2e⁻ and the cathode electrode 250 produces hydrogen by the reaction H₂O→+2e⁻→H₂+2OH⁻ when energy from a power source 252 is applied. Twice as much hydrogen is produced, by the total chemical formula H₂O→H₂+½O₂. Each electrode is connected from the current collector to the power supply be a metal wire 254. Central to the system is a separator membrane 256 that permits the flow of ions but does not allow the flux of hydrogen and oxygen gasses. The electrodes are desirably spaced at a distance of less than about five centimeters, preferably less than one centimeter, and more preferably at about one millimeter. Most preferably the electrodes are directly laminated to either face of the separator, allowing for greater compactness of the system. To efficiently move the gaseous product away from the electrode surface, the electrolyte is preferably circulated preferably by a pump 258. Hydrogen and oxygen are removed by peripheral ports 260 and collected. These single electrolyzers may also be stacked in series to form an electrolysis unit to produce larger amounts of hydrogen and oxygen.

Additionally, an electrolyzer can be operated with a solid electrolyte, such as an ion-exchange membrane. In this configuration, the electrodes are laminated on either side of the membrane, and water is circulated. A distinct advantage of this system is that it is more compact and has the potential to operate at higher current density. For example, a proton exchange membrane such as Nafion®-117 could be used, with the anode reaction being 2H₂O→4H⁺+4e⁻+O₂ and the cathode reaction being 4H⁺+4e⁻→2H₂.

### Example 1

### Preparation of an Electrode

About 0.15 grams of nickel powder (15 nm) and 1.35 grams of micron-nickel powder (0.5 micron) were blended in a vial. The resulting mixture was poured into a ¾″ die containing a ¾″ circle of expanded nickel metal. The die was then volumetrically compressed to 1500 psi and held at this pressure for 30 seconds. The resulting electrode was removed from the die and placed in a furnace at 500° C. for 1 hour.

### Example 2

### Electrode Performance

Cathodes were tested using a half-cell apparatus to independently test the electrode activity for hydrogen and oxygen generation. Electrolyte was a 33% KOH solution against a zinc-wire reference electrode. FIG. 8 shows a set of voltammograms for oxygen generation and a set for hydrogen generation. The most inefficient electrodes, shown as lines 300 are the lowest and highest lines on the hydrogen and oxygen curves, respectively. Electrodes made completely of micron-sized nickel also perform poor, shown on lines 302. However, with the addition of metal nanoparticles into the mixture, performance increases dramatically. Lines 304-307 illustrate this enhanced performance.

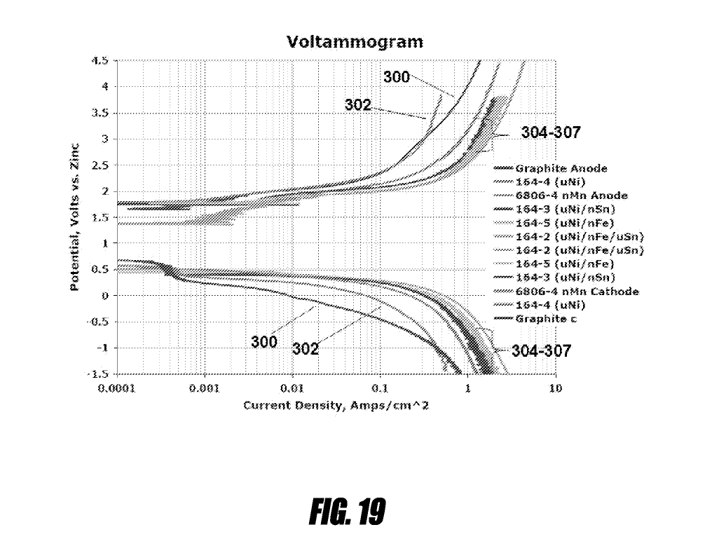

Referring to FIGS. 18 and 19, a comparison is shown between the efficiency and electrical performance of the described electrodes versus typical electrodes. Efficiency is defined as the amount of energy required to make hydrogen versus the energy inherent to the molecule. FIG. 18 shows the advantage of adding metal nanoparticles to the electrode in terms of efficiency. All pellet compositions incorporating metal nanoparticles have efficiencies over 70% at low current density.

The foregoing description is that of preferred embodiments having certain features, aspects, and advantages in accordance with the present inventions. Various changes and modifications also may be made to the above-described embodiments without departing from the spirit and scope of the inventions.

What is claimed is:

1. An electrode suitable for use in at least one electrochemical or catalytic application, the electrode comprising a volumetrically compressed and structurally stable mixture of reactive metal particles having a substantially high reactive surface area, and metal substrate particles having a lesser surface area than the reactive metal particles, said quantity of metal substrate particles being sufficient to provide structural stability to the electrode upon compression, whereby the electrode is volumetrically compressed to a percentage of the mixture's original volume so as to minimize volume while still permitting a sufficient amount of permeability to maintain a high catalytic efficiency.

2. The electrode of claim 1, further comprising a current collector.

3. The electrode of claim 2, wherein the current collector is embedded within the electrode.

4. The electrode of claim 1, wherein at least a portion of the reactive metal particles have a diameter of less than 100 nanometers.

5. The electrode of claim 4, wherein at least a portion of the reactive metal particles comprises particles having a diameter of less than 50 nanometers.

6. The electrode of claim 5, wherein at least a portion of the plurality of reactive metal particles comprises particles having a diameter of less than 10 nanometers.

7. The electrode of claim 1, wherein at least a portion of the metal substrate particles is selected from the group consisting of metals from groups 3-16, lanthanides, combinations thereof, and alloys thereof.

8. The electrode of claim 1, wherein at least a portion of the reactive metal particles is selected from the group consisting of metals from groups 3-16, lanthanides, combinations thereof, and alloys thereof.

9. The composition of claim 1, wherein at least a portion of the reactive metal particles comprises particles having an oxide shell.

10. The electrode of claim 1, wherein at least one face of the electrode has enhanced geometric surface area by adding contours.

11. The electrode of claim 10, wherein at least some of the surface area is contoured during volumetric compression.

12. The electrode of claim 1, wherein the electrode is sintered.

13. The electrode of claim 12, wherein the sintering temperature is between 100° C. and 900° C.

14. The electrode of claim 13, wherein the sintering temperature is between 400° C. and 700° C.

15. The electrode of claim 12, wherein the electrode is a gas or liquid diffusion electrode.

16. The electrode of claim 15, wherein first and second electrodes can be configured to permit the flow of electricity.

17. An electrochemical sensor comprising the composition of claim 16, wherein the sensor is configured to detect an analyte capable of undergoing electrochemical reaction at the sensor.
